(19) United States
(12) Patent Application Publication
(10) Pub. No.: US 2016/0014041 A1
(43) Pub. Date: Jan. 14, 2016

(54) RESOURCE REFERENCE CLASSIFICATION

(71) Applicant: HEWLETT-PACKARD DEVELOPMENT COMPANY, L.P., Houston, TX (US)

(72) Inventors: Pratyusa K Manadhata, Princeton, NJ (US); Sandeep N Bhatt, Princeton, NJ (US); William G Home, Princeton, NJ (US); Prasad V Rao, Princeton, NJ (US)

(21) Appl. No.: 14/770,261

(22) PCT Filed: Feb. 28, 2013
(86) PCT No.: PCT/US2013/028272

§ 371 Date: Aug. 25, 2015

(51) Int. Cl. H04L 12/911; H04L 29/08

(52) U.S. Cl. CPC H04L 47/783; H04L 67/02

(57) ABSTRACT

In one implementation, a resource reference classification system includes a selection engine and a classification engine. The selection engine is to access a plurality of resource request records based on resource requests intercepted from a plurality of clients, and to select resource request records from the plurality of resource request records intercepted from a client from the plurality of clients. Each resource request record from the plurality of resource request records includes a resource reference. The classification engine is to identify, independent of the client, a root resource reference and a plurality of child resource references of the root resource reference from the resource request records.

### BACKGROUND

Many resources accessible via communications links incorporate or refer to other resources. Such a hierarchy allows resources importing information from other resources, which can simply maintain a resource in a current state and distribution of a service providing the resource across multiple computing systems.

As an example, a resource such as a web page can refer to resources such as images, videos, or data sources that are accessed by a client in response to accessing the web page. In other words, the web page is accessed by a client and directs the client to access other resources to access other data or information that are included in or part of the web page. Advertisements, RSS (Rich Site Summary) feeds, JavaScript™ scripts, and CSS (Cascading Style Sheets) files are other examples of such resources.

### BRIEF DESCRIPTION OF THE DRAWINGS

FIG. 1 is a schematic block diagram of an environment including a resource reference classification system, according to an implementation.

FIG. 2 is a flowchart of a resource reference classification process, according to an implementation.

FIG. 3 is a flowchart of a resource reference classification process, according to another implementation.

FIG. 4 is a flowchart of a resource reference classification process, according to another implementation.

FIG. 5 is an illustration of temporal relationships among resource requests.

FIG. 6 is a schematic block diagram of a computing system hosting a resource reference classification system, according to an implementation.

### DETAILED DESCRIPTION

A resource is a data object (i.e., information or a data set) or data service that is accessible to a client via a server. A server is software hosted at a computing system that accepts resource requests (i.e., requests for resources) and provides responses including requested resources. As used herein, the term “resource” can refer to a resource abstractly or to any representation of a resource (e.g., difference encodings, presentations, sizes, or other representations). For example, a resource requested at a server can be a web page, and the resource can be provided to a client as a textual representation (e.g., Hypertext Markup Language (HTML)) of the web page. As another example, a requested resource can be an image file, and the resource can be provided to a client encoded by a MIME Base64 scheme as a group of ASCII characters. That is, the term resource (web page or image file in these examples) refers to the web page or image file abstractly and to the specific representations of the web page or image file provided to the client.

Resources that incorporate other resources can be referred to as root resources, and the resources incorporated by root references can be referred to as child resources. Thus, the designation of a resource as a child resource is relative to a root resource. Accordingly, a root resource can be a child resource of some other root resource, and a child resource of a root resource can be a root resource of another child resource. As a specific example, a first resource can incorporate a second resource (e.g., include a resource reference of the second resource that directs a client to send a resource request for the second resource), and the second resource can incorporate a third resource. Both the second resource and the third resource can be referred to as child resources of the first resource. Additionally, the first resource can be referred to as a root resource (i.e., a root resource of the second resource and/or the third resource), and the second resource can be referred to as a root resource (i.e., a root resource of the third resource).

Resources can be identified or described by resource references. A resource reference is an identifier of a resource. For example, Uniform Resource Identifiers (URIs) such as Uniform Resource Locators (URLs), Internet Protocol (IP) addresses, and host names are resource references. A root resource reference is an identifier of a root resource, and a child resource reference is an identifier of a child resource.

Typically, root resources are requested by clients in response to input from a user, and child resources are requested by clients in response to receipt of (or as directed by) root resources received by clients. As an example, a user inputs a root resource reference into a web (or Internet) browser or selects a root resource reference (e.g., clicks on a root resource reference such as a link using a pointing device), and the web browser sends a resource request to a server to request the root resource identified by the root resource reference. More specifically, as an example, the root resource is a web page and the root resource reference is the URL of the web page. The web browser sends an HTTP request including the URL to a web server, and the web server returns an HTML representation of the web page.

The web page (or the HTML representation of the web page) often incorporates a number of child resources. For example, such a web page often includes a number of child resource references that cause a web browser (here, client) to request child resources identified by those child resource references. For example, the web page includes HTML elements with sources external to the web page. As specific examples, child resource references can be URLs of images, videos, other web pages, CSS files or other formatting or markup information, scripts, tracking services, web beacons, or other resources that are included within the web page. Independent of input from the user, the web browser sends resource requests based on the child resource references to access the child resources (e.g., images, videos, other web pages, scripts, tracking services, web beacons, or other resources) that are incorporated in the web page. As a specific example, the web browser parses the web page (here, the root resource) and identifies URLs of resources that are incorporated in the web page (i.e., child resources of the web page), and generates resource requests for those resources without input from the user. After the web page (here, the root resource) and the child resources are received at the web browser, the web browser displays the web page (i.e., the content included in the web page itself and the content in the child resources of the web page) to the user.

In some implementations, a client such as a web browser can periodically refresh (e.g., send subsequent resource requests for) a resource such as a web page. This can be useful for resources that are frequently updated with updated or new content. For example, a web page can include a directive that directs a web browser to send a resource request including a resource reference of the web page at a particular interval (e.g., every 30 seconds, every minute, every five minutes, or some other interval). Alternatively, the web browser can be configured to send a resource request including a resource reference of the web page at a particular interval. As yet another example, the web browser can receive an indication from a server that updated content for the web page is available, and can send a resource request including a resource reference of the web page in response to the indication.

In some implementations, the resource reference included in each resource request (i.e., the resource requests sent to refresh the resource) can be referred to as a root resource reference. In other words, because the resource was first requested in response to input from the user, the resource can be considered a root resource even though it is periodically refreshed by the client. In other implementations, the resource reference included in each resource request can be referred to as a child resource. That is, the resource reference included in each resource request can be referred to as a child resource because the refreshed versions of the resource are requested independent of user input.

Because resources (e.g., root resources) can incorporate child resources, these resources can include content that is external and outside the control of the administrators of these resources. Such content can include images, video, text, scripts, interpretable instructions, executable instructions, or other data. In some instances, such content can be malicious. For example, a script or group of executable instructions can be constructed to take advantage of a security vulnerability in software and/or hardware (e.g., a client). Thus, child resources of a root resource can incorporate external security threats about which an administrator of the root resource is not aware. In other words, a child resource incorporated in a root resource (e.g., the root resource includes a child resource reference that identifies the child resource) can be or cause a root resource to be a security threat.

Some entities (e.g., corporations or enterprises) use communications proxies (e.g., web or HTTP proxies) or other methodologies to monitor resource references used by clients within their information technology infrastructure to access resources. Such monitoring can result in logs or lists of resource request records. Each resource request record includes information about a resource request such as, for example, a resource reference that was used to request a resource by a client. Although such logs or lists can be useful to determine whether clients have accessed resources that are known to be malicious (or security threats), such logs or lists do not indicate which resources are root resources (e.g., are requested in response to input from a user of a client) and which resources are child resources (e.g., are requested in response to receipt of root resources). In other words, such logs or lists do not indicate whether malicious resources were accessed in response to user input or in response to inclusion of child resource references within root resources.

Implementations discussed herein identify root resource references and child resource references of those root resource references based on resource request records. Thus, implementations discussed herein can determine whether a resource reference is a root resource reference or a child resource reference of a root resource reference. Said differently, implementations discussed herein can classify resource references as root resource references and child resource references.

This can be useful in identifying the source of accesses to malicious resources. For example, after a resource is known to be malicious, systems and methodologies discussed herein can determine whether that resource is a root resource (e.g., was requested in response to input from a user of a client) or is a child resource (e.g., was requested in response to receipt of a root resource) using resource references included at resource request records. Such classification can simplify a determination of how a security threat (or a resource that is or includes a security threat) was accessed, and formulation of a response to a security threat. If a malicious resource is a child resource, the root resource of that malicious resource can be assumed to be compromised and blocked to prevent further security threats from the root resource, or an administrator of the root resource of that malicious resource can be informed that the root resource includes a resource reference identifying that malicious resource.

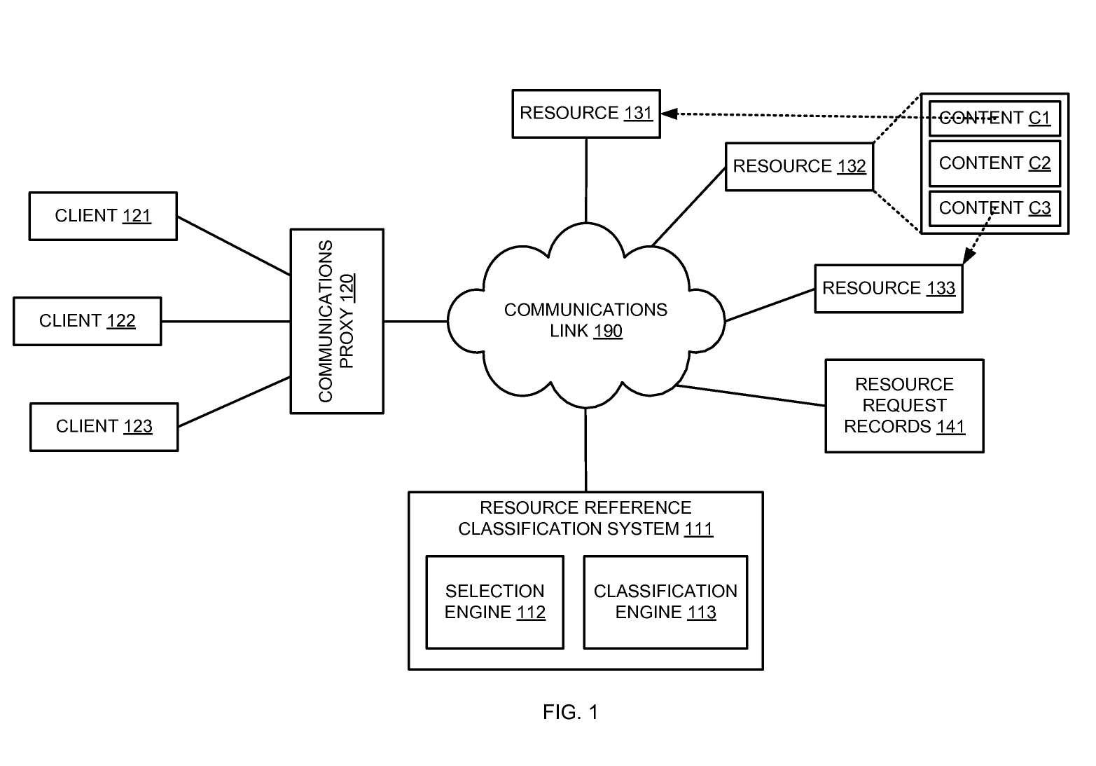

FIG. 1 is a schematic block diagram of an environment including a resource reference classification system, according to an implementation. Clients 121, 122, and 123 are software hosted at computing devices that provide resource requests to servers hosting resources, and receive those resources from those servers. Clients 121, 122, and 123 access those resources via communications proxy 120 and communications link 190. For example, clients 121, 122, and 123 send resource requests including resource references identifying resources accessible at servers and receive resources via communications proxy 120 and communications link 191. In some implementations, clients 121, 122, and 123 access resources via communications link 190 without a communications proxy.

Communications proxy 120 is software hosted at a computing device that acts as an intermediary for resource requests from clients. That is, clients send resource requests to communications proxy 120, and communications proxy 120 forwards those resource requests to servers hosting resources via communications link 190. In other words, communications proxy 120 intercepts resource requests. A resource request can be intercepted by accessing a copy of the resource request or a copy of a portion of the resource request. Alternatively, a resource request can be intercepted by accessing the resource request and then forwarding the resource request. Thus, a resource request can be intercepted and nevertheless proceed to its intended destination (e.g., a server).

In addition to intercepting resource requests, communications proxy 120 generates resource request records for intercepted resource requests. Typically, such resource request records are stored in logs (e.g., in a log file at a server or in a SAN (Storage Area Network)), which are accessible via a communications link. For example, as illustrated in FIG. 1, resource request records 141 can be generated by communications proxy 120 and accessed via communications link 190. Resource request records 141 can be stored at communications proxy 120 or remotely from communications proxy 120 at a data storage system or service. In some implementations, resource request records 141 can be output from communications proxy 120 as a real-time stream. That is, resource request records 141 can be output or accessible via communications link 190 as they are generated.

A resource request record is a record of a resource request, and can include a variety of data related to the resource request. For example, a resource request record can include a resource reference identifying a requested resource, a time at which a request record was sent from a client, an identifier of a client that sent a resource request, or other information related to a resource request. Thus, resource request records 141 describe resource requests sent from clients 121, 122, and 123.

As discussed above, in some implementations, clients 121, 122, and 123 access resources via communications link 190 without a communications proxy. In such implementations, or in implementation in which communications proxy 120 does not generate resource request records, a router, switch, gateway, or other component of communications link 190 can be configured as a network tap to intercept resource requests, and provide the resource requests (or copies thereof) to a server or service that generates resource request records 141. Similar to the implementations discussed above, resource request records 141 can be output in real-time or stored at a data storage device or service.

Communications link 190 includes devices, services, or combinations thereof that define communications paths between clients 121, 122, and 123, resources 131, 132, and 133 (or servers hosting resources 131, 132, and 133), a server hosting resource request records 141, resource reference classification system 111, and/or other devices or services. For example, communications link 190 can include one or more of a cable (e.g., twisted-pair cable, coaxial cable, or fiber optic cable), a wireless link (e.g., radio-frequency link, indicative link, optical link, or sonic link), or any other connectors or systems that transmit or support transmission of signals. Moreover, communications link 190 can include communications networks such as a switch fabric, an intranet, the Internet, telecommunications networks, or a combination thereof. Additionally, communications link 190 can include proxies, routers, switches, gateways, bridges, load balancers, and similar communications devices. Furthermore, the connections or communications paths illustrated in FIG. 1 and discussed herein can be logical or physical. Thus, for example, resource 132 may not be physically connected to communications link 190, but may be accessible via communications link 190 and a server and/or additional communications links.

Resource reference classification system 111 accesses resource request records 141 and classifies resource references as root resource references and child resource references. More specifically, selection engine 112 selects resource request records from resource request records 141 that are associated with a particular client (e.g., resource request records generated in response to resource requests sent from client 121), and classification engine 113 analyzes these resource request records to determine whether resource references included in these resource request records are root resource references or child resource references. In other words, classification engine 113 identifies root resource references and child resource references in the selected resource request records. Selection engine 112 and classification engine 113 are modules (i.e., combinations of hardware and software) that are components of resource reference classification system 111.

Although particular modules (i.e., combinations of hardware and software) such as engines are illustrated and discussed in relation to FIG. 1 and other example implementations, other combinations or sub-combinations of modules can be included within other implementations. Said differently, although modules illustrated in FIG. 1 and discussed in other example implementations perform specific functionalities in the examples discussed herein, these and other functionalities can be accomplished, implemented, or realized at different modules or at combinations of modules. For example, two or more modules illustrated and/or discussed as separate can be combined into a module that performs the functionalities discussed in relation to the two modules. As another example, functionalities performed at one module as discussed in relation to these examples can be performed at a different module or different modules. As a specific example, a valuation engine can be implemented using a group of electronic and/or optical circuits (or circuitry) rather than as instructions stored at memory and executed at a processor.

As an example of operation of a resource reference classification system, client 121 requests access to resource 132 by providing a resource request to a server hosting resource 132 via communications proxy 120 and communications link 190. Communications proxy 120 intercepts the resource request and generates a corresponding resource request record included at resource request records 141. Resource 132 is provided to client 121 in response to the resource request.

As illustrated in FIG. 1, resource 132 incorporates three content sections or elements: content C1, content C2, and content C3. Content C2 is internal to or included within resource 132. That is, data that defines content C2 is included within resource 132. Content C1 and content C3 are external to resource 132. That is, data that defines content C1 and content C3 is included within other resources (here, resources 131 and 133, respectively). More specifically in the example illustrated in FIG. 1, content C1 is (or incorporates data from) resource 131 and content C3 is (or incorporates data from) resource 133. As a specific example, resource 132 can include a resource reference identifying resource 131 at a portion of resource 132 associated with content C1 and a resource reference identifying resource 133 at a portion of resource 132 associated with content C3. Thus, resources 131 and 133 are incorporated into resource 132 by the resource references identifying resource 131 and resource 133. For example, resource 132 can be web page in which content C2 includes textual data, and content C1 and content C3 include images that are external (to resource 132) and are accessible via communications link 190 as resource 131 and resource 133, respectively.

In response to receiving resource 132, client 121 sends resource requests to access resource 131 and resource 133. For example, client 121 can identify a resource reference identifying resource 131 as being associated with content C1, and a resource reference identifying resource 133 as being associated content C3, respectively. Client 121 can then send a first resource request including the resource reference identifying resource 131 and a second resource request including the resource reference identifying resource 132.

Communications proxy 120 intercepts the first resource request and generates a corresponding resource request record included at resource request records 141. Communications proxy 120 also intercepts the second resource request and generates a corresponding resource request record included at resource request records 141. Resource 131 and resource 133 are then provided to client 121 in response to the resource requests. In addition to the specific resource accessed by client 121, clients 122 and client 123 also access resources, and communications proxy 120 generates resource request records corresponding to those resource requests, which are included at resource request records 141.

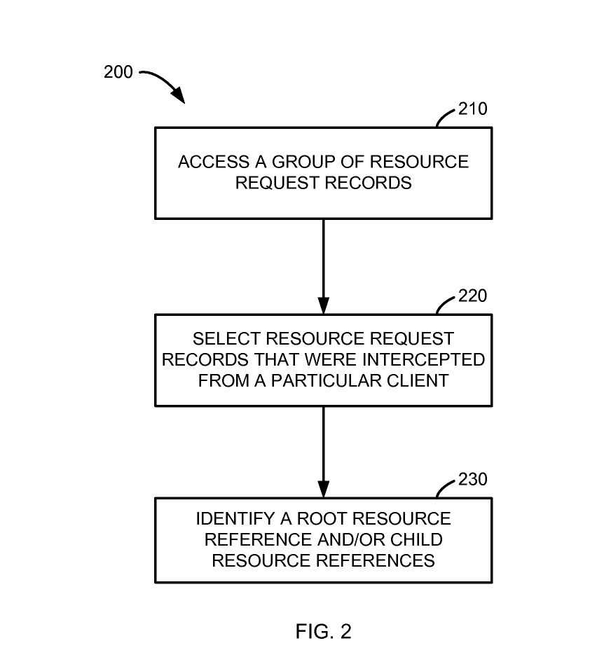

Resource reference classification system 111 can then identify root resource references and child resource references of each identified root resource reference using resource request records 141. For example, resource reference classification system 111 can implement a methodology such as the methodology illustrated in FIG. 2. FIG. 2 is a flowchart of a resource reference classification process, according to an implementation. Referring to elements of FIGS. 1 and 2, resource reference classification system 111 (e.g., using selection engine 112) accesses resource request records 141 at block 210 and selects resource request records intercepted from a particular client at block 220. In this example, resource reference classification system 111 accesses resource request records 141 and selects resource request records associated with client 121 (e.g., resource request records generated in response to resource requests set by client 121). For example, resource request records 141 can include an identifier such as an IP address, MAC address, host name, or other identifier of the client (or the computing device hosting the client) associated with each resource request record, and resource reference classification system 111 can access or filter the resource request records from resource request records 141 that include the identifier of client 121 at block 220.

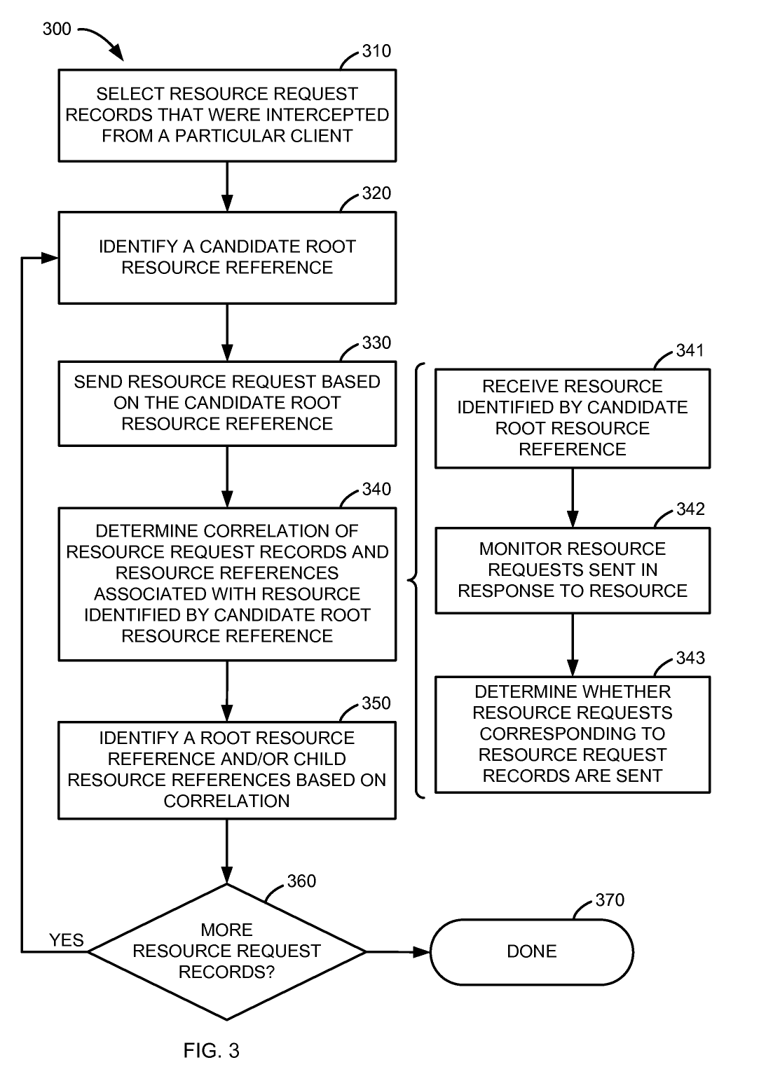

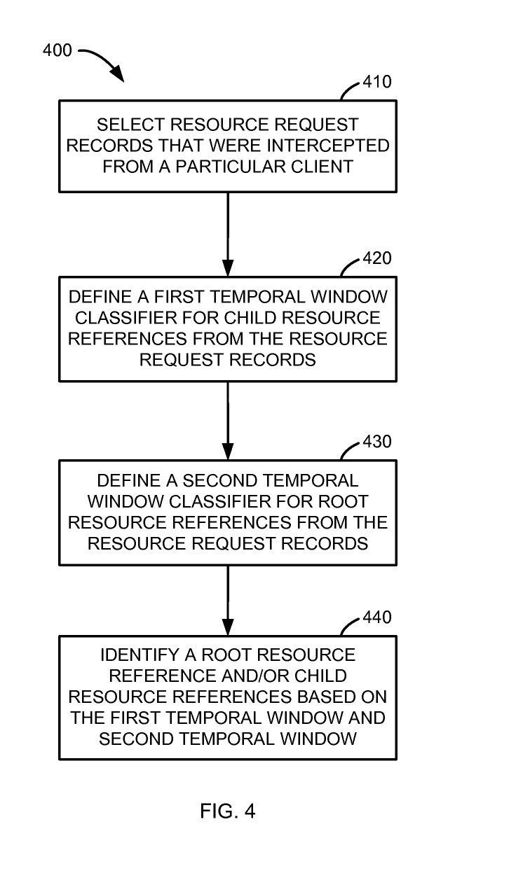

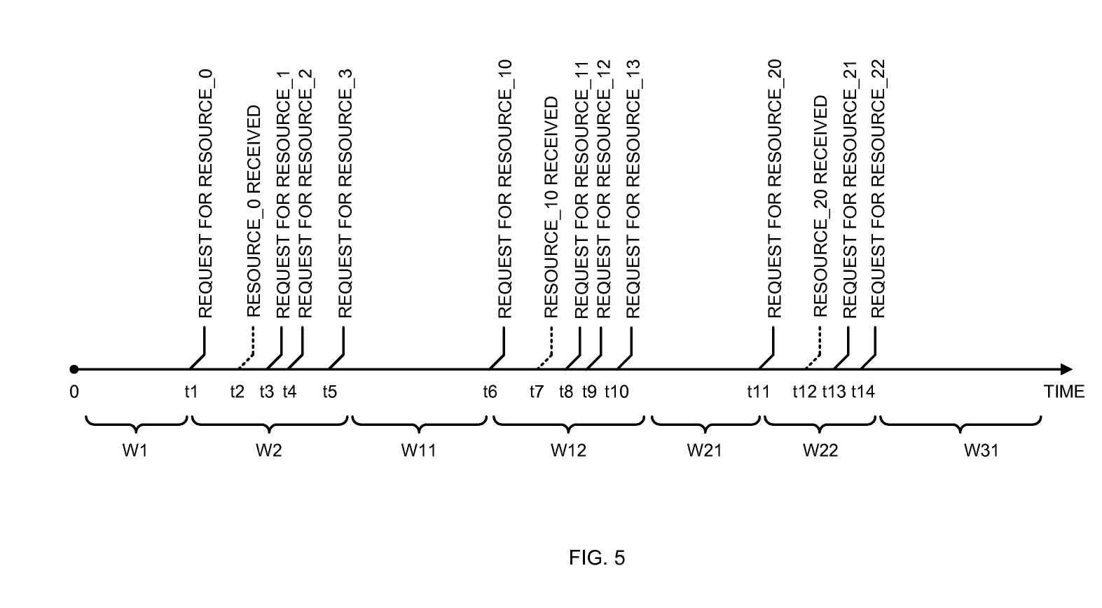

Resource reference classification system 111 (e.g., using classification engine 113) can then identify root resource references and/or child resource references included in the selected resource request records at block 230. For example, using replay methodologies such as the methodology discussed in more detail in relation to FIG. 3 and/or temporal analysis methodologies such as the methodology discussed in more detail in FIGS. 4 and 5. Process 200 illustrated in FIG. 2 is an example implementation of a resource reference classification process. In other implementations, a resource reference classification process can include additional, fewer, or rearranged blocks (or step) than illustrated in FIG. 2. For example, a resource reference classification process can include blocks or steps discussed in other examples herein.

FIG. 3 is a flowchart of a resource reference classification process, according to another implementation. Process 300 can be implemented at, for example, a resource reference classification system hosted at a computing system. Resource request records that were intercepted from a particular client are selected from a group of resource request records at block 310. For example, as discussed above in relation to FIGS. 1 and 2, a selection module of a resource reference classification system implementing process 300 can select resource request records intercepted from a particular client using an identifier of that client, and a classification module of the resource reference classification system can implement blocks 320, 330, 340 and 350.

A candidate root resource reference is then identified at block 320. A candidate root resource reference is a resource reference that is identified as potentially being a root resource reference, and can be identified using a variety of methodologies. For example, often the first (in time) or earliest resource request in a group of resource requests includes a root resource reference (i.e., the first resource request is for a root resource) and subsequent resource requests in the group include child resource references of that root resource reference (i.e., resource requests subsequent to the first resource request for a period of time are child resource identified or incorporated in the root resource). Accordingly, the selected resource reference requests can be arranged in order temporally (e.g., with the oldest in time resource reference request first and the most recent resource reference request last), and the resource reference of the first resource reference selected as the candidate root resource reference.

As another example, one or more heuristics can be applied to the resource references included within the selected resource reference requests to identify a candidate root resource reference. As a specific example, the resource requests can be HTTP requests and the resource references can be URLs. URLs that appear to identify images, video, or other resources that are likely to be embedded in a web page can be discarded as candidate root resource references, and the remaining URLs can be ordered temporally according to the resource request records including the URLs and the first such URL can be the candidate root resource reference. Said differently, resource references that have attributes of child resources can be excluded from consideration as candidate root resource references. URLs that appear to identify images, video, or other resources that are likely to be embedded in a web page can be identified (or classified) based on the structure (e.g., length of a URL, placement of characters, and/or numbers of characters) or content (e.g., characters and/or file extensions) of each URL. As an example of classification based on content, a URL that ends in file extension associated with such resources can be identified (or classified) as a child reference and discarded. Similarly, as an example of classification based on structure, URLs with many forward slashes, which can indicate that the resource identified by a particular URL is not a top- or high-level resource, can be identified as a child references and discarded. As yet another example of classification based on content, URLs that include terms or identifiers such as “embedded,” “content,” “image”, “images”, “video,” “media,” or other terms that indicate resources identified by those URLs are to be embedded within other resources such as web pages can be discarded.

As another specific example, a URL that appears to identify a top- or high-level resource can be selected as the candidate root resource reference. Said differently, resource references that have attributes (e.g., based on the structure or content of the resource reference) of root resources can be included for consideration as candidate root resource references. For example, a URL that does not include forward slashes after the top-level domain can be identified as a candidate root resource reference. As another example, a URL that includes three or fewer dot characters (‘.’) can be identified as a candidate root resource reference. As yet another example, a URL included at a list or known root references (e.g., well-known web site home pages such as www.nyt.com, www.cnn.com, etc.) can be identified as a candidate root resource reference.

As yet another example, a candidate root resource reference can be selected, for example as discussed above, and the resource request record including that candidate root resource reference can be analyzed to determine whether the resource request record includes an redirected resource reference. A redirected resource reference is a resource reference within another resource reference or response from a resource. In other words, the resource request record and/or that candidate root resource reference can be parsed to determine whether another resource reference is included within the resource request record and/or that candidate root resource reference. For example, that candidate root resource reference can identify a web tracking resource that tracks web traffic, and includes a query string with a resource reference (i.e., a redirected resource reference) that identifies a target resource to which a client is redirected. Alternatively, the resource request record can include redirection information such as an HTTP response including a URL (i.e., a redirected resource reference) to which a client should be redirected. If a redirected resource reference is found, the redirected resource reference can be identified as the candidate root resource reference. In other words, the redirected resource reference becomes the candidate root resource reference.

A resource request based on the candidate root resource reference is then sent at block 330 by the resource reference classification system implementing process 300. In one implementation, the resource request includes the candidate root resource reference and is sent to a server hosting the resource identified by the candidate root resource reference. Said differently, the resource reference classification system replays this resource request to mimic the actions of the client from which the resource request records selected at block 310 were intercepted.

The resource reference classification system then determines correlation of the resource request records (or the resource references included therein) selected at block 310 and resource references that are associated with the resource identified by the candidate root resource reference at block 340. For example, the resource reference classification system can determine to what extent resource references included in the resource (i.e., resource references that identify child resources of the resource) are also included in the resource request records selected at block 310.

Blocks 341, 342, and 343 illustrate an example implementation of block 340. At block 341, the resource identified by the candidate root resource reference is then received at the resource reference classification system. In this implementation, the resource reference classification system can be configured mimic a client and, therefore, sends resource requests for any child resources of the resource identified by the candidate root resource reference. In other words, the resource identified by the candidate root resource reference can include child resource references (i.e., to incorporate child resources), and resource requests including those child resource references are sent from the resource reference classification system to a server or a number of servers hosting the child resources to access those child resources as discussed above in the example of FIG. 1.

As illustrated at block 342, the resource reference classification system monitors resource requests sent in response to the resource (i.e., the resource identified by the candidate root resource reference). For example, the resource reference classification system can monitor its internal network communications operations, the state of a software module mimicking (or emulating) the client, or can include or communicate with another system to monitor resource requests sent by the resource reference classification system. As a specific example, the resource reference classification system (or a classification module thereof) can parse HTTP requests to be sent and record resource references within those HTTP requests.

The resource reference classification system then determines at block 343 whether resource requests corresponding to the resource request records (i.e., the resource request records selected at block 310) are sent by the resource reference classification system. A resource request can be said to correspond to a resource request record if a resource reference included in the resource request corresponds to (e.g., matches, is the same as, or is substantially the same as) a resource reference included in the resource request record. Thus, in some implementations, the resource reference classification system compares resource references included in resource requests sent by the resource reference classification system with the resource request records to determine whether resource requests corresponding to the resource request records are sent by the resource reference classification system at block 343. The resource reference classification system can determine the number or percentage of resource requests that correspond to the resource request records to define a correlation between the resource request records and resource references associated with resource (e.g., how well or to what extent the resource references associated with the resource correlate with the resource request records).

The resource reference classification system then identifies a root resource reference and/or child resource references at block 350 based on the correlation at block 340. As an example, the resource reference classification system then determines, based on child resources of the resource, whether the resource identified by the candidate root resource reference appears to be a root resource.

More specifically, for example, if resource references associated with the resource (i.e., resource references identifying child resources of the resource) are well-correlated with resource references included in the resource request records, the candidate root resource reference can be identified as a root resource reference at block 350. Additionally, the resource references included in the resource request records that correspond to resource references associated with the resource can be identified as child resource references of the root resource reference at block 350.

Resource references associated with the resource can be said to be well-correlated with resource references included in the resource request records if a statistically significant portion or percentage of resource references associated with the resource correspond to (e.g., match, are the same as, or are substantially the same as) resource references included in the resource request records. For example, resource references associated with the resource can be said to be well-correlated with resource references included in the resource request records if the percentage of resource references associated with the resource corresponding to resource references included in the resource request records is at least or greater than a predetermined threshold. As examples, the predetermined threshold can be 50%, 70%, 80%, 90%, or 95% for different resources. In other implementations, resource references associated with the resource can be said to be well-correlated with resource references included in the resource request records if the percentage of resource references associated with the resource corresponding to resource references included in the resource request records is at least some other statistically significant percentage. In other words, resource references associated with the resource can be said to be well-correlated with resource references included in the resource request records if a significant portion of the child resources of the resource are identified by resource references included in the resource request records.

In contrast, if resource references associated with the resource are not well-correlated with resource references included in the resource request records, the candidate root resource reference can be determined to not be a root resource reference. In some implementations, if resource references associated with the resource are not well-correlated with resource references included in the resource request records, the candidate root resource reference can be identified as a child resource reference. In some implementations, the resource references identifying the child resources of the resource (i.e., the resource identified by the candidate root resource reference) can be identified as child resource references regardless of the correlation of the resource references associated with the resource with resource references included in the resource request records. In other implementations, the resource references identifying the child resources of the resource are not identified as child resource references if resource references associated with the resource are not well-correlated with resource references included in the resource request records.

At block 360, if there are additional resource request records selected at block 310 that have not been considered (e.g., resource references included at those resource request records have not been identified as root resource references or as child resource references), process 300 proceeds to block 320 at which another candidate root resource reference is identified, and blocks 330, 340, 350, and 360 are repeated for that candidate root resource reference. Such iterations can proceed until all or resource request records are considered. If there are no additional resource request records selected at block 310 that have not been considered at block 360, process 300 can be complete and terminate. In some implementations (not shown), if there are no additional resource request records selected at block 310 that have not been considered at block 360, process 300 can return to block 300 to select resource request records that were intercepted from a different client, and blocks 320, 330, 340, 350, and 360 are repeated for those resource request records.

Similar to process 200, process 300 illustrated in FIG. 3 is an example implementation of a resource reference classification process. In other implementations, a resource reference classification process can include additional, fewer, or rearranged blocks (or step) than illustrated in FIG. 3. For example, a resource reference classification process can include blocks or steps discussed in other examples herein. Moreover, process 300 can be more applicable to some resource than to other resources. For example, process 300 can more accurately identify root resource references and/or child resource references based on root resources in which the child resources that are incorporated change infrequently than on root resource in which the child resources that are incorporated change frequently.

As another example of a resource reference classification process, FIG. 4 is a flowchart of a resource reference classification process, according to another implementation. Process 400 can be implemented at, for example, a resource reference classification system hosted at a computing system. Similar to block 310 of process 300, resource request records that were intercepted from a particular client are selected from a group of resource request records at block 410. The resource request records are then analyzed at blocks 420 and 430 to define temporal window classifiers for child resource references and root resource references.

FIG. 5 is an illustration of temporal relationships among resource requests. More specifically, the timeline illustrated in FIG. 5 shows the times at which a number of resources were requested by a client (e.g., illustrates the resource request records selected at block 410 arranged in temporal order). For example, the timeline can be constructed from resource request records generated at a communications proxy that intercepts resource requests and record a resource request record for each resource request at a log. The resource request records can include the resource reference included in the resource requests, an identifier of the client sending the resource request, and the time at which the resource request was intercepted.

Resources RESOURCE_0, RESOURCE_10, and RESOURCE_20 are root resources. Resources RESOURCE_1, RESOURCE_2, and RESOURCE_3 are child resources of RESOURCE_0. Resources RESOURCE_11, RESOURCE_12, and RESOURCE_13 are child resources of RESOURCE_10. Resources RESOURCE_21 and RESOURCE_22 are child resources of RESOURCE_20. Resource RESOURCE_0 was requested at time t1, and was received at time t2. Typically, information about the time at which a resource was received at a client is not included in resource request records, but these occurrences are illustrated here in dashed lines to facilitate understanding of various implementations. Similarly, data or information included in a resource itself is also typically not included in resource request records. Accordingly, root resource references and child resource references can be classified or identified independent of (e.g., without access to) a resource identified by a root resource reference or child resource reference.

Resources RESOURCE_1, RESOURCE_2, and RESOURCE_3 were requested (e.g., by a client) at times t3, t4, and t5, respectively. Resource RESOURCE_10 was requested at time t6, and was received at time t7. Resources RESOURCE_11, RESOURCE_12, and RESOURCE_13 were requested at times t8, t9, and t10, respectively. Resource RESOURCE_20 was requested at time t11, and was received at time t12. Resources RESOURCE_21 and RESOURCE_22 were requested at times t13 and t14, respectively.

Temporal windows (or time periods) W1, W2, W11, W12, W21, W22, and W31 illustrate typical patterns of resource requests for a client. Temporal windows W1, W11, W21, and W31 illustrate periods of time during which few or no resource requests are set from a client before a root resource is requested. Temporal windows W2, W12, and W22 illustrate periods of time during which a number of resource requests for child resources are sent from a client after a root resource is requested (and subsequently received).

More specifically, after a period of inactivity or low activity (i.e., lack of or few resource requests) labeled as temporal window W1, the client sends a resource request for resource RESOURCE_0 at t1 (i.e., time t1). Such a temporal window can be said to be associated with or for root resources, root resource references, or resource requests for root references because activity following such periods indicates a request for a root resource has been sent from a client. Following t1, a significant increase in resource requests are observed during temporal window W2 (by comparison to the number of resource requests observed during temporal window W1). The resource requests observed during temporal window W2 are resource requests for child resources of resource RESOURCE_0. In other words, because the client requests child resources of a root resource without interaction from a user of the client, a number of resource requests can be observed within a temporal window following a request for a root resource (or after the root resource is received in resource to the request for the root resource). Such a temporal window can be said to be associated with child resources, child resource references, or resource requests for child resource references because such temporal windows are characterized by the resource requests for child resources sent from a client during these temporal windows.

Typically, a temporal window associated for child resource references is followed by a temporal window for root resource references of inactivity or low activity during which the client (or a user of the client) consumes (e.g., reviews, parses, or analyzes) the complete root resource including any child resources as illustrated by temporal window W11. Similar to temporal window W2, temporal windows W12 and W22 are associated with child resource references. Temporal windows W21 and W31 are associated with root resource references similar to temporal windows W1 and W11.

Referring again for FIG. 4, the resource request records selected at block 410 can be analyzed at block 420 and 430 to define a first temporal window classifier for child resource references and a second temporal window classifier for root resource references. A temporal window classifier is a characteristic or a group of characteristics that describe or characterize a temporal window. As examples, such characteristics can include a length of time such as a number of seconds or number of milliseconds, a number of resource requests, and/or other characteristics.

Such temporal window classifiers can be defined by analyzing the resource request records along a timeline as illustrated in FIG. 5. For example, a resource reference classification system can identify periods of low activity or inactivity (here, few resource request records) followed by brief periods with a significant increase or spike in activity. The lengths, number of resource requests during, and/or other characteristics of the periods of low activity or inactivity can be used to define a temporal window classifier for root resource references. For example, these characteristics can be averaged or analyzed to derive statistical properties therefrom to define a temporal window classifier for root resource references. Similarly, lengths, number of resource requests during, and/or other characteristics of the periods of increased activity can be used to define a temporal window classifier for child resource references.

In some implementations, training data (or ground truth) such as known root resource references can be used to define boundaries between temporal windows for root resource references and temporal windows for child resource references. Such boundaries can be input to blocks 420 and 430 to improve identification of characteristics and definition of temporal window classifiers. In some implementations, a resource reference classification system implementing process 400 can use heuristics such as those discussed above (e.g., structure of resource references, content of resource references, or a combination thereof) to label or identify resource references included in the resource request records as root resource references and child resource references. Such labeled resource references can be input as training data to blocks 420 and 430 to improve identification of characteristics and definition of temporal window classifiers.

In other words, using machine learning techniques, the resource reference classification system implementing process 400 can use labeled resource references to infer or determine at what times boundaries of temporal windows for root resource references and temporal windows for child resource references should be established. That is, for example, a time associated with a resource request record including a root resource reference can be interpreted to be the end of a temporal window for root resource references and the beginning of a temporal window for child resource references. Similarly, a time associated with a last resource request record from a group of resource request records including child resource references can be interpreted to be the end of a temporal window for child resource references and the beginning of a temporal window for root resource references. The resource reference classification system can then analyze the characteristics of temporal windows for root resource references and temporal windows for child resource references to define temporal window classifiers. Said differently, the resource reference classification system defines temporal window classifiers by characterizing temporal windows for root resource references and temporal windows for child resource references.

The resource reference classification system then uses the first and second temporal window classifiers at block 440 to identify root resource references and/or child resource. That is, the resource reference classification system identifies resource request records associated with times within temporal windows that satisfy the first temporal window classifier (i.e., temporal windows with characteristics that are the same as or substantially similar to the first temporal window classifier) as occurring within a temporal window for child resource references, and identifies or classifies the resource references included in those resource request records as child resource references. Similarly, the resource reference classification system identifies resource request records associated with times within temporal windows that satisfy the second temporal window classifier as occurring within a temporal window for root resource references, and identifies or classifies the resource references included in those resource request records as root resource references.

Process 400 illustrated in FIG. 4 is an example implementation of a resource reference classification process. In other implementations, a resource reference classification process can include additional, fewer, or rearranged blocks (or step) than illustrated in FIG. 4. For example, a resource reference classification process can include blocks or steps discussed in relation to FIG. 4 and/or other examples herein. As a specific example, in some implementations, process 400 can proceed from block 440 to block 410 to select resource request records that were intercepted from a different client.

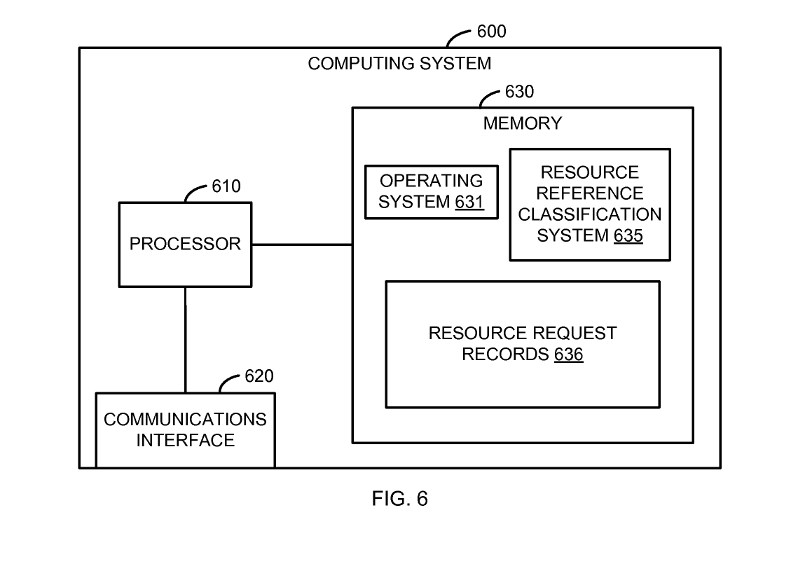

FIG. 6 is a schematic block diagram of a computing system hosting a resource reference classification system, according to an implementation. In the example illustrated in FIG. 6, computing system 600 includes processor 610, communications interface 620, and memory 630. Computing system 600 can be, for example, a personal computer such as a desktop computer or a notebook computer, a tablet device, a smartphone, a distributed computing system (e.g., a group, grid, or cluster of individual computing systems), or some other computing system. In some implementations, a computing system hosting a resource reference classification system is referred to itself as a resource classification system.

Processor 610 is any combination of hardware and software that executes or interprets instructions, codes, or signals. For example, processor 610 can be a microprocessor, an application-specific integrated circuit (ASIC), a graphics processing unit (GPU) such as a general purpose GPU (GPGPU), a distributed processor such as a cluster or network of processors or computing systems, a multi-core or multi-processor processor, or a virtual or logical processor of a virtual machine.

Communications interface 620 is a module via which processor 610 can communicate with other processors or computing systems via a communications link. As a specific example, communications interface 620 can include a network interface card and a communications protocol stack hosted at processor 610 (e.g., instructions or code stored at memory 630 and executed or interpreted at processor 610 to implement a network protocol) to receive and send data. As specific examples, communications interface 620 can be a wired interface, a wireless interface, an Ethernet interface, a Fiber Channel interface, an InfiniBand interface, an IEEE 802.11 interface, or some other communications interface via which processor 610 can exchange signals or symbols representing data to communicate with other processors or computing systems.

Memory 630 is a processor-readable medium that stores instructions, codes, data, or other information. As used herein, a processor-readable medium is any medium that stores instructions, codes, data, or other information non-transitorily and is directly or indirectly accessible to a processor. Said differently, a processor-readable medium is a non-transitory medium at which a processor can access instructions, codes, data, or other information. For example, memory 630 can be a volatile random access memory (RAM), a persistent data store such as a hard-disk drive or a solid-state drive, a compact disc (CD), a digital versatile disc (DVD), a Secure Digital™ (SD) card, a MultiMediaCard (MMC) card, a CompactFlash™ (CF) card, or a combination thereof or of other memories. In other words, memory 630 can represent multiple processor-readable media. In some implementations, memory 630 can be integrated with processor 610, separate from processor 610, or external to computing system 600.

Memory 630 includes instructions or codes that when executed at processor 610 operating system 631 and resource reference classification system 635. Memory 630 is also operable to store resource request records 636. For example, during run-time of operating system 631, resource request records 636 can be stored at memory 630 by a communications proxy, and resource reference classification system 635 can analyze resource request records 636 to identify root resource references and child resource references. As another example, computing system 600 can include (not illustrated in FIG. 6) a processor-readable medium access device (e.g., CD, DVD, SD, MMC, or a CF drive or reader), and can access resource request records at another processor-readable medium via that processor-readable medium access device. As yet another example, computing system 600 can access resource request records via communications interface 620.

In some implementations, computing system 600 can be a virtualized computing system. For example, computing system 600 can be hosted as a virtual machine at a computing server. Moreover, in some implementations, computing system 600 can be a computing appliance or virtualized computing appliance, and operating system 631 is a minimal or just-enough operating system to support (e.g., provide services such as a communications protocol stack and access to components of computing system 600 such as communications interface 620) resource reference classification system 635. In yet other implementations, computing system 600 can be, for example, a router, network switch, or other device that performs functionalities in addition to functionalities related to a resource reference classification system.

Resource reference classification system 635 can be accessed or installed at computing system 600 from a variety of memories or processor-readable media. For example, computing system 600 can access resource reference classification system 635 at a remote processor-readable medium via a communications interface (not shown). As a specific example, computing system 610 can be a network-boot device that accesses operating system 631 and resource reference classification system 635 during a boot process (or sequence).

As another example, computing system 600 can include (not illustrated in FIG. 6) a processor-readable medium access device (e.g., CD, DVD, SD, MMC, or a CF drive or reader), and can resource reference classification system 635 at a processor-readable medium via that processor-readable medium access device. As a more specific example, the processor-readable medium access device can be a DVD drive at which a DVD including an installation package for one or more components of resource reference classification system 635 are accessible. The installation package can be executed or interpreted at processor 610 to install one or more components of resource reference classification system 635 at computing system 600 (e.g., at memory 630 and/or at another processor-readable medium such as a hard-disk drive). Computing system 600 can then host or execute resource reference classification system 635.

In some implementations, resource reference classification system 635 (or components such as various modules thereof) can be accessed at or installed from multiple sources, locations, or resources. For example, some components of resource reference classification system 635 can be installed via a communications link (e.g., from a file server accessible via a communication link and communications interface 520), and other components of resource reference classification system 635 can be installed from a DVD.

In other implementations, components of resource reference classification system 635 can be distributed across multiple computing systems. That is, some components of resource reference classification system 635 can be hosted at one computing system and other components of resource reference classification system 635 can be hosted at another computing system.

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. As another example, functionalities discussed above in relation to specific modules or elements can be included at different modules, engines, or elements in other implementations. Furthermore, it should be understood that the systems, apparatus, and methods described herein can include various combinations and/or sub-combinations of the components and/or features of the different implementations described. Thus, features described with reference to one or more implementations can be combined with other implementations described herein.

As used herein, the term “module” refers to a combination of hardware (e.g., a processor such as an integrated circuit or other circuitry) and software (e.g., machine- or processor-executable instructions, commands, or code such as firmware, programming, or object code). A combination of hardware and software includes hardware only (i.e., a hardware element with no software elements), software hosted at hardware (e.g., software that is stored at a memory and executed or interpreted at a processor), or hardware and software hosted at hardware.

Additionally, as used herein, the singular forms “a,” “an,” and “the” include plural referents unless the context clearly dictates otherwise. Thus, for example, the term “module” is intended to mean one or more modules or a combination of modules. Moreover, the term “provide” as used herein includes push mechanisms (e.g., sending data to a computing system or agent via a communications path or channel), pull mechanisms (e.g., delivering data to a computing system or agent in response to a request from the computing system or agent), and store mechanisms (e.g., storing data at a data store or service at which a computing system or agent can access the data). Furthermore, as used herein, the term “based on” means “based at least in part on.” Thus, a feature that is described as based on some cause, can be based only on the cause, or based on that cause and on one or more other causes.

What is claimed is:

1. A resource reference classification system, comprising:
a selection engine to access a plurality of resource request records based on resource requests intercepted from a plurality of clients, each resource request record from the plurality of resource request records including a resource reference, and
to select resource request records from the plurality of resource request records intercepted from a client from the plurality of clients; and
a classification engine to identify, independent of the client, a root resource reference and a plurality of child resource references of the root resource reference from the resource request records.

2. The system of claim 1, wherein the classification engine identifies the plurality of child resource references of the root resource reference independent of resources associated with the resource request records.

3. The system of claim 1, wherein the classification engine identifies the root resource reference and the plurality of child resource references of the root resource reference independent of resources associated with the resource request records.

4. The system of claim 1, wherein the classification engine:
defines a temporal window classifier for child resource references based on the resource request records; and
identifies the plurality of child resource references of the root resource reference based on the temporal window classifier.

5. The system of claim 1, wherein the classification engine:
selects the resource reference included at a resource request record from the resource request records as a candidate root resource reference;
sends a resource request including the candidate root resource reference; and
identifies a resource reference included at a resource request record from the resource request records as a child resource reference of the candidate root resource reference if a corresponding resource request is sent in response to the resource request.

6. The system of claim 1, wherein the classification engine:
selects the resource reference included at a resource request record from the resource request records as a candidate root resource reference;
sends a resource request including the candidate root resource reference; and
determines that the candidate root resource reference is the root resource reference based on correlation of resource references associated with the resource and the resource request records.

7. The system of claim 1, wherein the classification engine:
selects the resource reference included at a resource request record from the resource request records as a candidate root resource reference;
determines that the resource request record includes a redirected resource reference; and
identifies the redirected resource reference as the candidate root resource reference.

8. A processor-readable medium storing code representing instructions that when executed at a processor cause the processor to:
select resource request records from a plurality of resource request records generated in response to resource requests intercepted from a client from a plurality of clients, each resource request record from the plurality of resource request records including a resource reference;
identify the resource reference included at a resource request record from the resource request records as a candidate root resource reference, the candidate root resource reference associated with a resource;
send a resource request including the candidate root resource reference; and
identify a resource reference included at a resource request record from the resource request records as a child resource reference of the candidate root resource reference if a corresponding resource request is sent in response to the resource request.

9. The processor-readable medium of claim 8, wherein the candidate root resource reference is associated with an earliest resource request record from the resource request records.

10. The processor-readable medium of claim 8, wherein the candidate root resource reference is identified based on structure, content, or a combination thereof of the resource references included at the resource request records.

11. The processor-readable medium of claim 8, further comprising code representing instructions that when executed at the processor cause the processor to:
identify a resource reference included at a resource request record from the resource request records as a child resource reference of the candidate root resource reference based on a structure of the resource reference.

12. The processor-readable medium of claim 8, further comprising code representing instructions that when executed at the processor cause the processor to:
identify a resource reference included at a resource request record from the resource request records as a child resource reference of the candidate root resource reference based on content of the resource reference.

13. The processor-readable medium of claim 8, further comprising code representing instructions that when executed at the processor cause the processor to:
determine whether the candidate root resource reference is a root resource reference based on correlation of resource references associated with the resource and the resource request records.

14. A processor-readable medium storing code representing instructions that when executed at a processor cause the processor to:
select resource request records from a plurality of resource request records generated in response to resource requests intercepted from a client from a plurality of clients, each resource request record from the plurality of resource request records including a resource reference;
define a temporal window classifier for child resource references based on the resource request records; and
identify a root resource reference and a plurality of child resource references of the root resource reference based on the temporal window classifier.

15. The processor-readable medium of claim 14, wherein the temporal window classifier is a first temporal window classifier, the processor-readable medium further comprising code representing instructions that when executed at the processor cause the processor to:
define a second temporal window classifier for root resource references based on the resource request records, the root resource reference and the plurality of child resource references of the root resource reference are identified based on the first temporal window classifier and the second temporal window classifier.

16. The processor-readable medium of claim 14, further comprising code representing instructions that when executed at the processor cause the processor to:
identify candidate root resource references and candidate child resource references based on structures of the resource references included at the resource request records.

17. The processor-readable medium of claim 14, further comprising code representing instructions that when executed at the processor cause the processor to:
identify candidate root resource references and candidate child resource references based on structure, content, or combinations thereof of the resource references included at the resource request records.

18. The processor-readable medium of claim 14, wherein the root resource reference and the plurality of child resource references of the root resource reference are identified based on the temporal window classifier and content of the resource references included at the resource request records.

19. The processor-readable medium of claim 14, wherein the root resource reference and the plurality of child resource references of the root resource reference are identified based on the temporal window classifier and structures of the resource references included at the resource request records.
